(19) United States
(12) Patent Application Publication
(10) Pub. No.: US 2025/0291189 A1
(43) Pub. Date: Sep. 18, 2025

(54) DISPLAY APPARATUS HAVING PAIR OF DISPLAY UNITS PRESENTING IMAGES TO LEFT AND RIGHT EYES

(71) Applicant: CANON KABUSHIKI KAISHA, Tokyo (JP)

(72) Inventor: KAZUHARU OSAWA, Tokyo (JP)

(21) Appl. No.: 19/075,256

(22) Filed: Mar. 10, 2025

(30) Foreign Application Priority Data
Mar. 12, 2024 (JP) 2024-038085

(51) Int. Cl. G02B 27/01

(52) U.S. Cl. CPC G02B 27/0172; G02B 27/0176; G02B 2027/0138

(57) ABSTRACT

A pair of display units each include a lens. The lens includes a first clearance portion, a second clearance portion, and a third clearance portion provided in different positions in the outer edge when viewed in the direction of the optical axis. The lens has a substantially mirror symmetric shape relative to an imaginary plane passing through a point on the first clearance portion and the optical axis.

### BACKGROUND

### Field

The present disclosure relates to a display apparatus such as a head-mounted display (hereinafter HMD) that presents an image to a user via an optical element.

### Description of the Related Art

Mainstream HMDs are configured to have two display units that present images to the user's left and right eyes. Each display unit includes a display to show images and optical elements such as lenses that focus images from the display, so that each display unit presents images to the user using these optical elements. Optical elements, specifically lenses, are made by cutting, or molding using a high-precision mold. For cost reduction, it is preferable to use optical elements shared between both left and right display units.

Various components are arranged around the optical elements inside and outside the HMD. For example, the user's nose is positioned between the left and right display units outside the HMD. Inside the HMD, vision adjustment means for adjusting the user's image visibility, and monitoring means for monitoring the user, are arranged around the optical elements. To avoid interference between the nose and the display units while ensuring a sufficient viewing angle of the optical elements for the user to see images, it is common to provide a clearance portion, such as a cutout, to the optical elements in a position facing the user's nose. The display apparatus described in Japanese Patent Application Publication No. 2009-036835 shows an example where a clearance portion is provided to the optical elements to avoid interference with the user's nose. Positioning of vision adjustment means and monitoring means simply around an optical element will lead to a size increase of the display unit. Therefore, an approach to avoid a size increase of the display unit is to provide another clearance portion in the optical element, and to position the vision adjustment means and monitoring means at the other clearance portion.

However, the attempt to use optical elements shared between the left and right display units, each having a plurality of clearance portions could lead to an unnecessary loss of the viewing angle of the optical elements.

### SUMMARY

An object of the present disclosure is to provide a technique that makes it possible to reduce the size and cost of the pair of left and right display units in a display apparatus while maintaining a sufficient viewing angle.

To achieve the above object, a display apparatus of the present disclosure includes the following:
a pair of display units configured to present an image to left and right eyes, the pair of display units each including an optical element,
wherein the optical element includes
a first clearance portion, a second clearance portion, and a third clearance portion provided in different positions in an outer edge of the optical element when viewed in a direction of an optical axis, and has
a substantially mirror symmetric shape relative to an imaginary plane passing through a point on the first clearance portion and the optical axis.

The present disclosure makes it possible to reduce the size and cost of the pair of left and right display units in a display apparatus while maintaining a sufficient viewing angle.

Further features of the present disclosure will become apparent from the following description of exemplary embodiments with reference to the attached drawings.

### BRIEF DESCRIPTION OF THE DRAWINGS

FIGS. 1A and 1B are outer views of an HMD 1 that is the first embodiment;

FIGS. 2A and 2B are diagrams illustrating the structure of the display units in the HMD 1 according to one or more aspects of the present disclosure;

FIGS. 3A and 3B are diagrams illustrating the characteristics and effects of the HMD 1 according to one or more aspects of the present disclosure;

FIGS. 4A and 4B are outer views of an HMD 2 according to one or more aspects of the present disclosure;

FIGS. 5A and 5B are diagrams illustrating the structure of the display units in the HMD 2 according to one or more aspects of the present disclosure;

FIGS. 6A and 6B are diagrams illustrating the characteristics and effects of the HMD 2 according to one or more aspects of the present disclosure; and

FIGS. 7A and 7B are diagrams explaining an HMD with a comparative design.

### DESCRIPTION OF THE EMBODIMENTS

Embodiments of the present disclosure will be illustratively described with respect to the following examples. It should be noted that the configurations disclosed in the following examples, e.g., functions, materials, shapes of components, and their relative arrangements, are examples in the forms associated with the claims, and are not intended to limit the scope of the claims to the configurations disclosed in these examples. The issues resolved by the configurations disclosed in the following examples, or effects or advantages achieved by the disclosed configurations are not intended to limit the scope of the claims.

### First Embodiment

First, an HMD 1, which is a display apparatus according to a first embodiment of the present disclosure, is described.

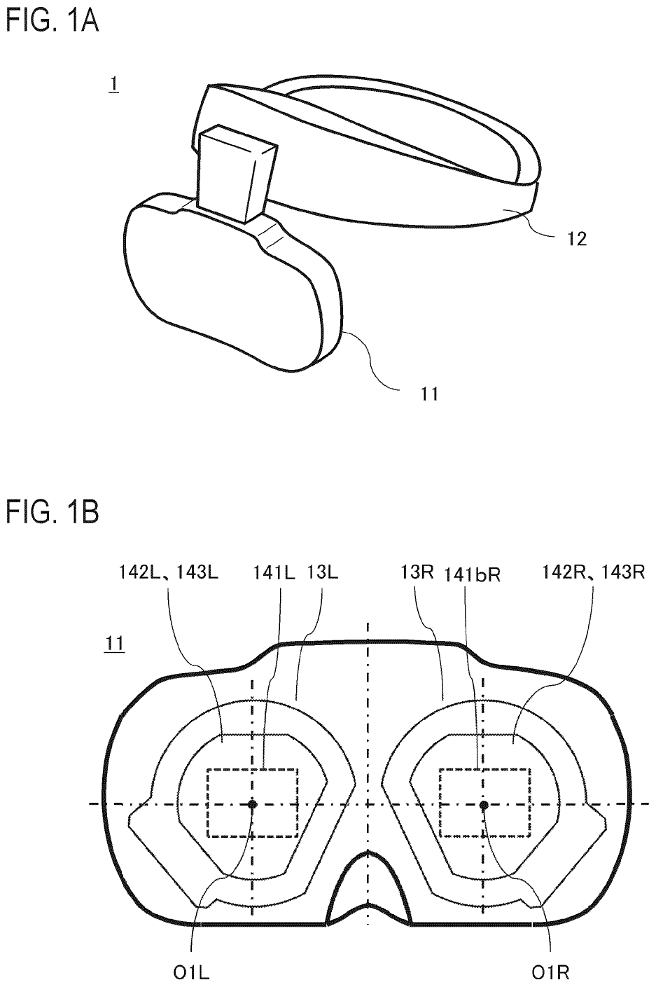

FIG. 1A is a perspective view of the HMD 1. The HMD 1 is made up of an HMD main body 11 and an attachment band 12. The attachment band 12 is a headband part securely attached to the head of a user. The HMD main body 11 is held by the attachment band 12 to be positioned in front of the user's eyes.

FIG. 1B is a diagram of the HMD main body 11 viewed from the user. The HMD main body 11 includes a pair of display units 13L and 13R that present images to the user's left and right eyes. The display units 13L and 13R include displays 141L and 141R, and lenses 142L and 142R and cover glasses 143L and 143R as the optical elements to be described later, respectively. The user can visibly perceive images displayed on the displays 141L and 141R by observing the displays 141L and 141R through the lenses 142L and 142R and the cover glasses 143L and 143R.

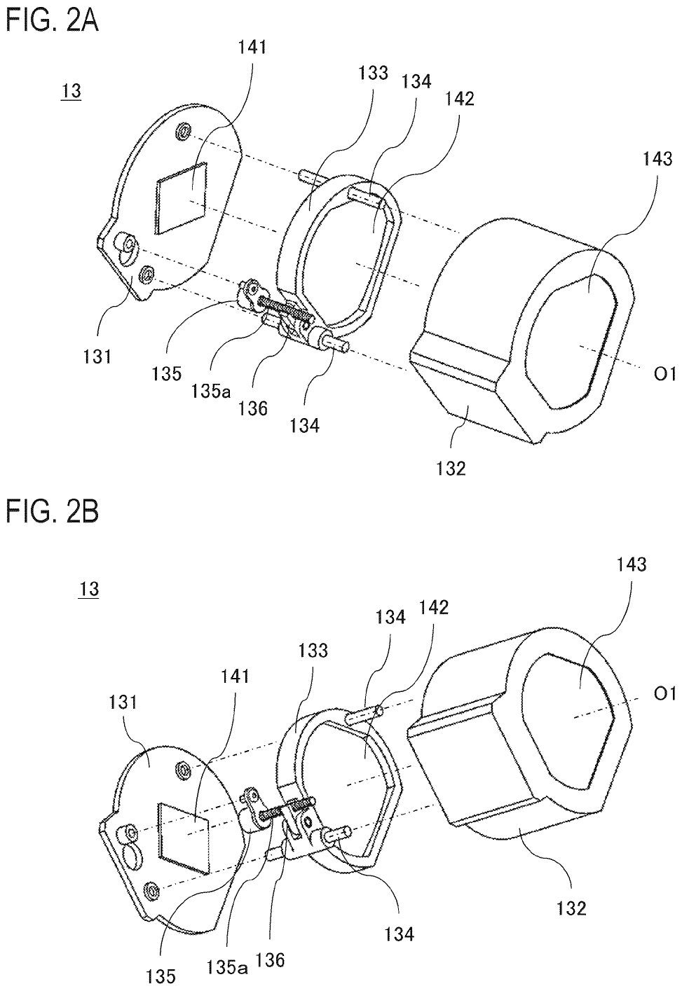

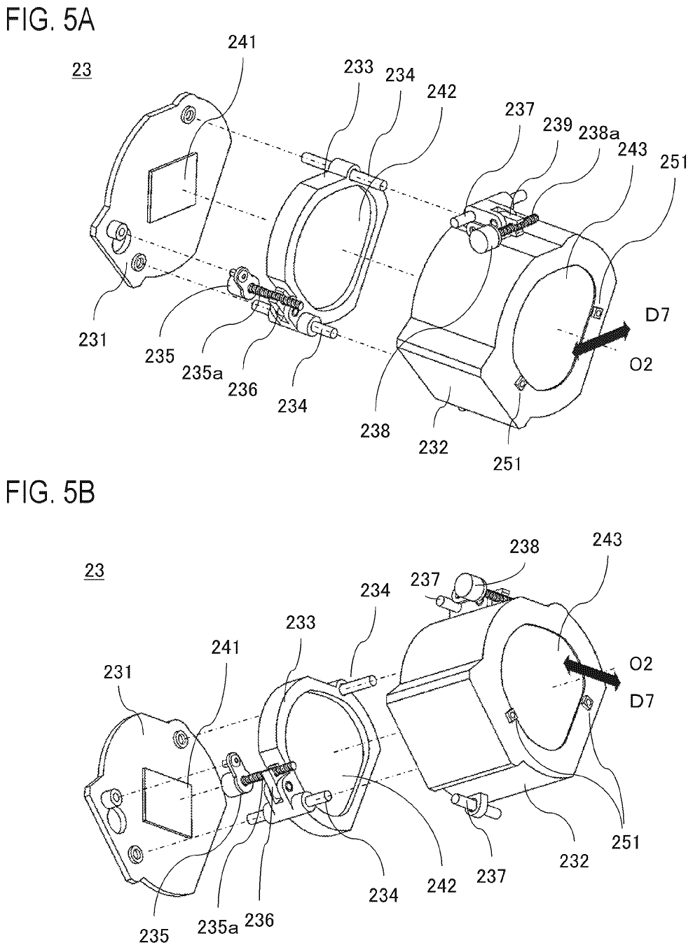

The display unit 13L for the left eye and the display unit 13R for the right eye are configured to be mirror symmetric about the vertical axis. The components in the left eye display unit 13L and the right eye display unit 13R are assigned reference numerals with “L” and “R” added at the end, respectively. In the following description of the display units 13L and 13R, the structure of the display unit will be described mainly with respect to the left eye display unit 13L when there is no need to distinguish the left and right display units, and the letter “L” may be omitted in the explanation. The reference numerals are shown without “L” in FIGS. 2A and 2B and FIGS. 5A and 5B. Various structures of the right eye display unit 13R are the same as those of the left eye display unit 13L.

The structure of the display units 13L and 13R of the HMD 1 is described with reference to FIGS. 2A and 2B. FIGS. 2A and 2B are exploded perspective views of the left eye display unit 13L. As mentioned above, the letter “L” is omitted from the reference numerals in the drawings.

The display unit 13 is mainly composed of the display 141, the lens 142, the cover glass 143, a display base 131, a cover 132, a lens holder 133, guide bars 134, a motor 135, and a coupling member 136. In the display unit 13, the center axis of the display 141, and of the optical system formed by optical elements such as the lens 142 and the cover glass 143, is indicated by O1 and referred to as optical axis. If each optical element has an optical center, the optical axis may be defined as the line passing through these centers. In the following description, a direction may be described as “substantially parallel to” the optical axis. This does not mean that the direction must be exactly parallel to the optical axis. This expression is intended to mean that if a component that is slightly inclined to the optical axis can provide the effects similar to a parallel component, such a component can also be adopted as part of the present disclosure (can be considered the same as parallel).

The display 141 in the display unit 13 presents images for the left eye and is secured to the display base 131. The lens 142 is a convex lens, for example, and secured to the lens holder 133. The lens holder 133 is held by the two guide bars 134 extending through the lens holder along the optical axis O1 and is held such as to be movable in directions substantially parallel to the optical axis O1. The two guide bars 134 are held at both ends by the display base 131 and the cover 132. The motor 135 has a lead shaft 135a, and is secured to the display base 131. The cover glass 143 is secured to the cover 132. The two components, the display base 131 and the cover 132, make up the exterior of the display unit 13. The lens holder 133 holds the coupling member 136 engaging with the threads on the lead shaft 135a of the motor 135, so that, when the lead shaft 135a is rotated by the motor 135, the lens holder 133 and the lens 142 are moved in directions substantially parallel to the optical axis O1 via the coupling member 136. As described above, a driver made up of the motor 135, the coupling member 136, and the guide bars 134 move the lens 142 that is an optical element in the display unit 13 in directions substantially parallel to the optical axis O1. This movement provides vision adjustment effects such as changes in the focal length of the images as viewed by the user.

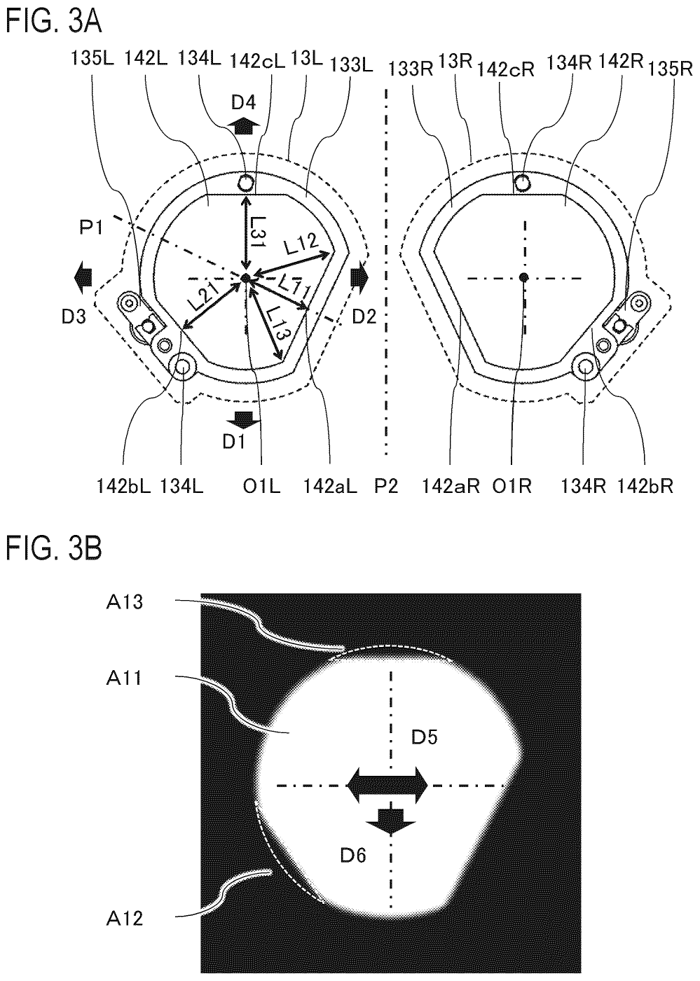

The HMD 1 has the following characteristics as will be described with reference to FIG. 3A. FIG. 3A shows the left and right display units 13L and 13R as viewed by the user in the directions of optical axes O1L and O1R. Since this is a description of internal structures, the outer contours of the display units 13L and 13R (display bases 131L and 131R, and covers 132L and 132R) are shown with broken lines, and the cover glasses 143L and 143R are not shown. The following description of the left eye display unit 13L shall apply to the right eye display unit 13R, too.

In the HMD 1 of this embodiment, the lens 142 that is an optical element in the display unit 13 includes a first clearance portion 142a, a second clearance portion 142b, and a third clearance portion 142c in its outer contour. In this embodiment, the first clearance portion 142a, second clearance portion 142b, and third clearance portion 142c are cutouts provided in a circular lens. In this embodiment, the term clearance portion refers to a feature in an outer contour of an optical element where the distance from the optical axis is locally reduced. Namely, a clearance portion here refers to a recessed area in the outer shape of the optical element (lens) when viewed in the direction of the optical axis, which appears as a portion recessed toward the optical axis from the outermost portion of a circular arc substantially along an imaginary circle about the optical axis. The first clearance portion 142a to the third clearance portion 142c in this embodiment are formed as linear cutouts in the outer edge of the lens 142 when viewed in the direction of the optical axis O1. The term linear is used here to describe the shape of each clearance portion merely because it refers to the (two-dimensional) shape when viewed in the direction of the optical axis. Obviously, each clearance portion has a flat surface when described in three dimensions because the lens 142 has a thickness in the direction of the optical axis. For example, distance L11 between the outer contour and the optical axis O1 is shorter in the first clearance portion 142a than distances L12 and L13 between the outer contour and the optical axis O1 in the neighboring parts. Similarly, the distance between the outer contour and the optical axis O1 is shorter in the second clearance portion 142b and the third clearance portion 142c than that in the neighboring parts.

In this embodiment, the second clearance portion 142b and the third clearance portion 142c are substantially mirror symmetric about a plane P1 passing through the center of the first clearance portion 142a and the optical axis O1. Here, the plane P1 is an imaginary plane (second imaginary plane) that passes through the center of the contour of the first clearance portion 142a in the contour line of the lens 142 when viewed in the direction of the optical axis of the display unit 13, and the optical axis. The phrase “substantially mirror symmetric” does not mean that applicable parts must be exactly mirror symmetric. This expression is intended to mean that if the parts that are not exactly mirror symmetric due to slight differences can provide the effects similar to exactly mirror symmetric parts, such parts can also be adopted in the applicable configuration of the present disclosure.

In this embodiment, the first clearance portion 142a is positioned on the lower side of the lens 142 indicated by direction D1 and on the side closer to the other display unit (display unit 13R) indicated by direction D2 in the outer edge of the lens 142 when viewed in the direction of the optical axis. This clearance portion is a nose clearance portion provided to avoid interference with the nose of the user wearing the HMD 1. The second clearance portion 142b is positioned on the lower side of the lens 142 and on the side opposite to the side where the pair of lenses 142L and 142R face each other in the outer edge of the lens 142 when viewed in the direction of the optical axis. The second clearance portion 142b in this position is adjacent the driver (motor 135, guide bars 134, and coupling member 136) for driving the lens 142 in directions substantially parallel to the optical axis O1. This clearance portion is a driver clearance portion provided to avoid interference with the driver when the driver needs to be positioned closer to the optical axis O1 for the size reduction of the display unit 13. The third clearance portion 142c is positioned on the upper side of the lens 142 in the outer edge of the lens 142 when viewed in the direction of the optical axis.

In the two display units 13L and 13R, the lenses 142L and 142R with these clearance portions are positioned substantially in mirror symmetry about a plane P2 perpendicular to the left and right direction. The plane P2 is an imaginary plane (first imaginary plane) extending in a direction perpendicular to the direction in which the pair of lenses 142L and 142R are aligned. The plane P2 can also be called an imaginary plane substantially parallel to the direction of the optical axis of each of the pair of display units 13L and 13R.

The effects provided by this embodiment are now described in comparison to a comparative design.

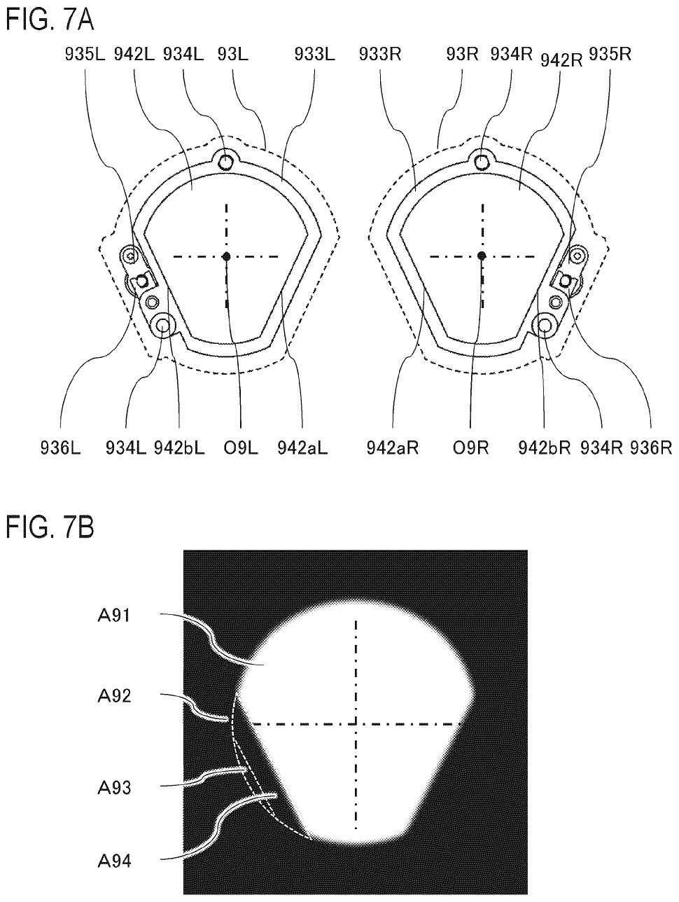

The configuration of an HMD that is a display apparatus with the comparative design is described with reference to FIG. 7A. FIG. 7A shows the left and right display units 93L and 93R in the HMD with the comparative design as viewed by the user in the direction of the optical axes O9L and O9R of the display units 93L and 93R. Since this is a description of internal structures of the display units 93L and 93R, their outer contours are shown with broken lines in FIG. 7A. Although not shown, the HMD with the comparative design is the same as the HMD 1 in overall configuration, made up of an HMD main body and an attachment band. The HMD main body with the comparative design is a display apparatus that has two display units 93L and 93R. The comparative HMD is able to change the focal length of images viewed by the user by driving the lenses 942L and 942R that are optical elements in the direction of the optical axes O9L and O9R in the display units 93L and 93R. These and other configurations similar to those of the HMD 1 will not be described in detail. The lens holder 933 and the driver (guide bars 934, motor 935, and coupling member 936) have the same configurations as those of the HMD 1 and description of these parts will be omitted.

The display unit 93L for the left eye and the display unit 93R for the right eye are configured to be mirror symmetric about the vertical axis. In the following description of the display units 93L and 93R, the structure of the display unit will be described mainly with respect to the left eye display unit 93L when there is no need to distinguish the left and right display units, and the letter “L” may be omitted in the explanation. Various structures of the right eye display unit 93R are similar to those of the left eye display unit 93L.

The lens 942 includes a first clearance portion 942a and a second clearance portion 942b. The first clearance portion 942a is a nose clearance portion provided to avoid interference with the user's nose, and the second clearance portion 942b is a driver clearance portion provided to avoid interference with the driver. The second clearance portion 942b allows the driver to be positioned closer to the optical axis O9, thereby enabling a reduction in the outer shape of the display unit 93. The lens 942 has the first clearance portion 942a and the second clearance portion 942b in symmetry, i.e., the left eye lens 942L will be in register with the right eye lens 942R if shifted or rotated about the optical axis O9. Therefore, the same lens can be used for both lenses 942L and 942R, which helps to reduce costs.

On the other hand, positioning the first clearance portion 942a and the second clearance portion 942b in symmetry causes some issues. For example, in some cases, the display unit 93 could be accommodated inside the HMD main body (not shown) with a smaller second clearance portion 942b than the first clearance portion 942a. The second clearance portion 942b in such cases would still need to be cut as large as the first clearance portion 942aL in order to make the lenses 942 symmetric. This results in the viewing angle of the images seen by the user unnecessarily reduced.

FIG. 7B is a diagram illustrating the viewing angle of the images the user sees in the left eye display unit 93L. A91 denotes the area of the viewing angle of the image visible to the user. A92 denotes the area of the viewing angle lost by providing the second clearance portion 942b. A93 denotes the area of the viewing angle that would be lost if the second clearance portion 942b were cut only to a minimal necessary extent. The area indicated by A94 would be unnecessarily lost from the viewing angle by designing both left and right lenses 942L and 942R the same.

The advantageous effects of this embodiment will be described with reference to FIGS. 3A and 3B.

As shown in FIG. 3A, the first clearance portion 142a is positioned on the lower side of the lens 142 and on the side closer to the other display unit in the HMD 1 of this embodiment. This clearance portion is a nose clearance portion provided to avoid interference with the user's nose. The second clearance portion 142b is adjacent the driver, i.e., it is a driver clearance portion provided to avoid interference with the driver. In the HMD 1, instead of shaping the first clearance portion 142a and the second clearance portion 142b in symmetry, the second clearance portion 142b and the third clearance portion 142c are shaped in symmetry about the plane P1. This structure allows the first clearance portion 142a and the second clearance portion 142b to have different cutout shapes while enabling the left and right lenses 142L and 142R to have the same shape. In the HMD 1, the lens 142L will be in register with the lens 142R if shifted or rotated about the optical axis O1, and vice versa. Therefore, even when the first clearance portion 142a needs to be cut largely, the second clearance portion 142b can be maintained to a minimum necessary cut shape.

FIG. 3B is a diagram illustrating the viewing angle of the images the user sees in the left eye display unit 13L. All denotes the area of the viewing angle of the image visible to the user. A12 denotes the area of the viewing angle lost by providing the second clearance portion 142b. A13 denotes the area of the viewing angle lost by providing the third clearance portion 142c.

Let us now compare the viewing angle of the HMD 1 shown in FIG. 3B with the viewing angle of the HMD 9 with the comparative design shown in FIG. 7B. By forming the second clearance portion 142b, which is the driver clearance portion, as a minimum necessary cutout, the loss of viewing angle can be reduced from area A92 in FIG. 7B to area A12 in FIG. 3B. A13 in FIG. 3B denotes the area that is lost by providing the third clearance portion 142c. Even so, the lost area of the viewing angle, area A13 and area A12 combined, is reduced. Moreover, as will be described later, the driver and eye cameras can be positioned adjacent the third clearance portion 142c to accommodate various configurations in the space provided by the clearance portion, which helps to make the display unit 13 even smaller.

As described above, the HMD 1 of this embodiment includes the second clearance portion 142b as a driver clearance portion, which helps to make the display unit 13 smaller as well as to allow the same lens to be used as the left and right lenses 142L and 142R, enabling cost reduction. Namely, the HMD 1 of this embodiment can prevent the unnecessary reduction of the viewing angle, which was an issue in HMDs with the comparative design, while allowing the size and the cost of the display unit 13 to be reduced.

In the HMD 1 described above, the second clearance portion 142b, and not the third clearance portion 142c, is adjacent the driver that drives the lens 142 that is an optical element in directions substantially parallel to the optical axis O1. The configuration that can provide the effects of the present disclosure is not limited to this example. For example, the third clearance portion 142c, and not the second clearance portion 142b, may be positioned adjacent the driver. The second clearance portion 142b or the third clearance portion 142c may be positioned adjacent other components than the driver that drives an optical element along the optical axis O1. For example, the second clearance portion 142b may be positioned adjacent a driver that drives the optical element in other directions, or an eye camera that monitors the user's eye, as in the HMD 2 to be described later. The effects of the present disclosure can be achieved by positioning these driver and eye camera near a clearance portion. These components need not necessarily be positioned outside the outer contour of the optical element.

While the first clearance portion 142a as a nose clearance portion is positioned on the lower side of the lens 142 and on the side closer to the other display unit in the HMD 1 described above, the first clearance portion 142a need not necessarily be formed as a nose clearance portion. For example, if the driver clearance portion needs to be a larger cutout than the nose clearance portion, it will be more beneficial to position the first clearance portion 142a adjacent the driver in terms of size reduction of the display unit 13 and prevention of viewing angle loss.

While the clearance portions of the lens 142 in the HMD 1 described above are cutouts in the circular lens, the clearance portions need not necessarily be cutouts to achieve the effects of the present disclosure. As described above, the term clearance portion herein refers to a feature in the outer contour of the optical element where the distance from the optical axis O1 is locally reduced. For example, if the optical element has a non-circular outer shape as in the HMD 2 to be described later, and has no clearly cut notches, the effects of the present disclosure can be achieved if the shape includes portions where the distance from the optical axis O1 is locally reduced.

While the second clearance portion 142b and the third clearance portion 142c are mirror symmetric in the lens 142 of the HMD 1 described above, the configuration is not limited to this example. The effects of the present disclosure can be achieved even if these clearance portions are not completely mirror symmetric, as long as the optical performance is not greatly lost, and the driver or the eye camera adjacent the clearance portions are not adversely affected.

In the HMD 1 described above, the lens 142 is provided with three clearance portions, i.e., first, second, and third clearance portions 142a, 142b, and 142c. These clearance portions are provided in different positions in the outer edge of the lens 142 when viewed in the direction of the optical axis of the display unit 13. In the left and right display units 13L and 13R, the lenses 142L and 142R are positioned substantially in mirror symmetry about the plane P2. In actuality, the outer contour (outer edge) of the lens 142L or 142R may include protrusions and indentations (remnants of the molding gate or positioning notches) that hardly affect optical performance. The effects of the present disclosure can be achieved even with the presence of such protrusions and indentations, and these need not be mirror symmetric about the plane P2.

In FIGS. 3A, L11, L21, and L31 respectively indicate the minimum distance from the first, second, and third clearance portions 142a, 142b, and 142c to the optical axis O1. Distance L21 is equal to distance L31 (second distance), and distance L11 (first distance) is different from L21 and L31 in the HMD 1. Namely, the second clearance portion 142bL or 142bR and the third clearance portion 142cL or 142cR are cut more than the first clearance portion 142aL or 142aR. For example, in a configuration where several clearance portions of different optimal cut sizes such as the nose clearance portion and the driver clearance portion are provided, the present disclosure allows each clearance portion to have an ideal cut size. The effect of reducing the loss of viewing angle, in particular, achieved in this case will be significant. Namely, to better achieve the effect of the present disclosure, a preferred configuration is that two of the three clearance portions have the same minimum distance to the optical axis O1 and the remaining one clearance portion has a different minimum distance.

Moreover, distance L11 is shorter than distance L21 and distance L31 in the HMD 1 described above. The more largely the clearance portion is cut, i.e., the shorter the distance from the optical axis O1 to the outer edge of the clearance portion in the optical element, the more the viewing angle will be lost. Therefore, to minimize the loss of viewing angle, it is preferable to make the clearance portion small so that the distance between the outer edge and the optical axis is as long as possible. Two of the distances L11, L21, and L31 are equal. Therefore, L21 being longer than L11 means that L31 is equal to L21 and longer than L11, which helps minimize the loss of viewing angle. Namely, to better achieve the effect of the present disclosure, a preferred configuration is that two of the three clearance portions have the same minimum distance to the optical axis O1 and the remaining one clearance portion has a shorter minimum distance.

With the increase in the viewing angle of images in HMDs in recent years, the size of the optical elements has also increased. The cut size of the nose clearance portion provided to avoid interference with the user's nose tends to be large accordingly. Therefore, one of the clearance portion 142a, clearance portion 142b, and clearance portion 142c that has the shortest minimum distance from the optical axis O1 should preferably be positioned on the lower side of the optical element and on the side closer to the other display unit.

The horizontal viewing angle is considered the most important for the user viewing images in an HMD to perceive the spatial extent. A wide field of view at arm's length is also important in HMD applications where the user performs imaginary operations within a CG space or an MR space. In the case with FIG. 3B, it is preferable to set a large viewing angle for the user in the horizontal direction indicated by direction D5 and on the lower side indicated by direction D6. In the HMD 1, the first clearance portion 142a is positioned on the lower side of the lens 142 indicated by direction D1 and on the side closer to the other display unit indicated by direction D2. The second clearance portion 142b is positioned on the lower side of the lens 142 indicated by direction D1 and on the side opposite to the other display unit indicated by direction D3. The third clearance portion 142c is positioned near the upper end of the lens 142 indicated by direction D4. Each clearance portion is thus positioned where it does not cause a large loss of viewing angle so that large horizontal and nearby fields of view can be secured.

As discussed above, one of the three clearance portions is preferably positioned on the lower side of the optical element and on the side closer to the other display unit, one is preferably positioned on the lower side of the optical element and on the side opposite to the other display unit, and the remaining one is preferably positioned near an upper end of the optical element.

The driver of the HMD 1 includes the motor 135 as an actuator that drives (generates the driving force to move) the lens 142 that is an optical element in a predetermined direction. The driver further includes the guide bars 134 as a guide mechanism that guides the driven lens 142 in the predetermined direction. The clearance portions provided to the lens 142 adjoin the driver that includes these components. In a driving mechanism, in particular, an actuator that drives an object and a guide mechanism that guides the object generally take up space along the driving direction and tend to become bulky. These actuator and guide mechanism can cause an increase in the outer shape of the display unit 13 when arranging a driving mechanism in the display unit 13. Therefore, the effect of enabling a size reduction of the display unit 13, in particular, is achieved more effectively by providing clearance portions in the lenses 142L and 142R and placing the actuator and guide mechanism adjacent these clearance portions. As described above, the driver includes at least one of an actuator that drives an optical element in the display unit 13 in a predetermined direction, and a guide mechanism that guides the driven optical element in the predetermined direction, and preferably adjoins a clearance portion provided in the optical element.

Some drivers include parts that are preferably positioned away from each other. For example, the two guide bars 134 can guide the lens 142 more precisely if they are positioned away from each other. In the HMD 1, the second clearance portion 142b in the display unit 13 is adjacent the motor 135 and one guide bar 134, while the third clearance portion 142c is adjacent another guide bar 134. This configuration allows the driver to be split and positioned in separate clearance portions so that the display unit 13 has a smaller outer shape, as well as the positioning precision of the optical element can be improved. As described above, the driver that drives the optical element in the display unit 13 is preferably adjacent two of the clearance portions, i.e., the second and third clearance portions 142b and 142c.

The display unit 13 also includes the cover glass 143 as an optical element in addition to the lens 142. A clearance portion provided in the lens 142 causes a loss in the viewing angle for the user. The cover glass 143 is another optical element (second optical element) aligned with the lens 142 (first optical element) along the direction of the optical axis. Therefore, providing a clearance portion for the cover glass in the same position (corresponding position) as the clearance portion for the lens 142 does not affect the viewing angle. This means that a clearance portion can be provided in the same position for the cover glass 143 so that the driver and an eye camera are positioned there, to make the display unit 13 even smaller. As described above, the display unit 13 includes a plurality of optical elements aligned along the direction of the optical axis, one of which includes a first clearance portion 142a, a second clearance portion 142b, and a third clearance portion 142c in its outer contour. In this case, the other optical elements preferably have a clearance portion in a position corresponding to at least one of the first clearance portion 142a, second clearance portion 142b, and third clearance portion 142c relative to the optical axis O1.

### Second Embodiment

Next, an HMD 2, which is a display apparatus according to a second embodiment of the present disclosure, is described. Description of some of the matters in the second embodiment that are the same as in the first embodiment may be omitted as appropriate in the following. The matters in the second embodiment that are not specifically described are to be understood as the same as in the first embodiment.

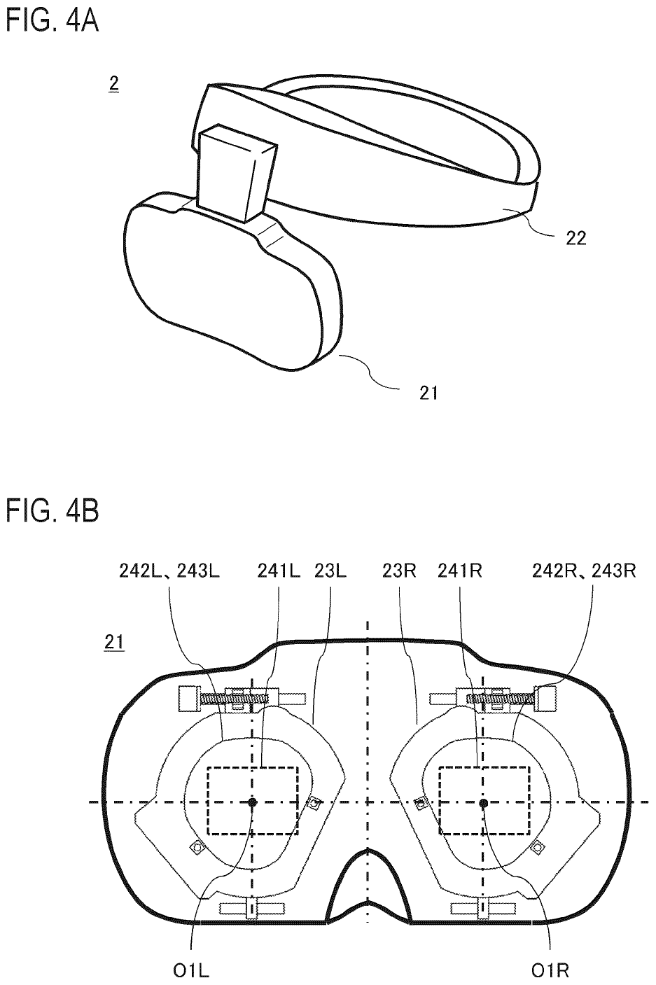

FIG. 4A is a perspective view of the HMD 2. Similarly to the HMD 1, the HMD 2 is made up of an HMD main body 21 and an attachment band 22. FIG. 4B is a diagram of the HMD main body 21 viewed from the user. Similarly to the HMD 1, the HMD 2 includes a pair of display units 23L and 23R. Similarly to the HMD 1, the display units 23L and 23R present images to the user using displays 241L and 241R, and optical elements (lenses 242L and 242R and cover glasses 243L and 243R).

Similarly to the HMD 1, the display unit 23R for the right eye and the display unit 23L for the left eye are configured to be mirror symmetric about the vertical axis. The components in the left eye display unit 23L and the right eye display unit 23R are assigned reference numerals with “L” and “R” added at the end, respectively. In the following description of the display units 23L and 23R, the structure of the display unit will be described mainly with respect to the left eye display unit 23L when there is no need to distinguish the left and right display units, and the letter “L” may be omitted in the explanation. Various structures of the right eye display unit 23R are the same as those of the left eye display unit 23L.

The structure of the display units 23L and 23R of the HMD 2 is described with reference to FIGS. 5A and 5B. FIGS. 5A and 5B are exploded perspective views of the left eye display unit 23L. As mentioned above, the letter “L” is omitted from the reference numerals in the drawings.

The display unit 23 is mainly composed of the following parts. The display unit 23 has the same configurations as the display unit 13 of the HMD 1 in terms of the display 241, lens 242, cover glass 243, display base 231, cover 232, lens holder 233, first guide bars 234, first motor 235, and first coupling member 236. Second guide bars 237, a second motor 238, a second coupling member 239, and eye cameras 251 are the parts that are not provided in the display unit 13 of the HMD 1.

The display 241 in the display unit 23 of the HMD 2 has the same configuration as that of the display 141 in the display unit 13 of the HMD 1. Similarly, the display base 231, lens holder 233, first guide bars 234, first motor 235, and first coupling member 236 have the same configurations as the display base 131, lens holder 133, guide bars 134, motor 135, and coupling member 136. In the HMD 2, similarly to the HMD 1, the lens 242 is moved by the driver including the first motor 235, the first coupling member 236, and the first guide bars 234 in directions substantially parallel to the optical axis O2 to allow the focal length of images to be changed.

The display unit 23 in the HMD 2 further includes the two second guide bars 237, second motor 238, second coupling member 239, and two eye cameras 251. The cover 232 is held by the two second guide bars 237 extending through the cover along the left and right direction indicated by D7 in the drawings and is held such as to be movable in the direction D7. The two second guide bars 237 are held at both ends by the HMD main body 21 (not shown). The second motor 238 has a lead shaft 238a, and is secured to the HMD main body 21 (not shown). The cover 232 holds the second coupling member 239 that engages with the threads of the lead shaft 238a of the second motor 238. When the lead shaft 238a is rotated by the second motor 238, the cover 232 moves in the direction D7 via the second coupling member 239, thereby driving the lens 242, the cover glass 243, and other peripheral mechanisms in the direction D7.

As described above, the driver made up of the second motor 238, second coupling member 239, and second guide bars 237 drives the lens 242 and the cover glass 243 that are optical elements in the left and right direction indicated by D7 in the display unit 23. This configuration allows the optical elements to move in the left and right direction, providing vision adjustment effects by placing the optical elements in optimal positions relative to the user's left and right eyes. The image display performance can thereby be improved. Hereinafter, in the HMD 2 the driver that drives the lenses 242 in directions substantially parallel to the optical axis O2 to adjust the image focal length shall be referred to as first driver. The driver that drives the lenses 242 and the cover glasses 243 in the left and right direction indicated by D7 to improve the image display performance shall be referred to as second driver.

The first driver is configured to displace the position of the lens 242 (lens holder 233) in the display unit 23 (display base 231 and cover 232), similarly to the driver in the HMD 1. The second driver is configured to displace the position of the display unit 23 (display base 231 and cover 232) within the HMD main body 21.

The two eye cameras 251 are held on the covers 232 to monitor the user's eyes. The monitoring results of the eyes are used, for example, for calculation of target positions of the lenses 242 and cover glasses 243 driven by the second driver, calculation of the user's line of sight, and other processing in the HMD that uses the line of sight information.

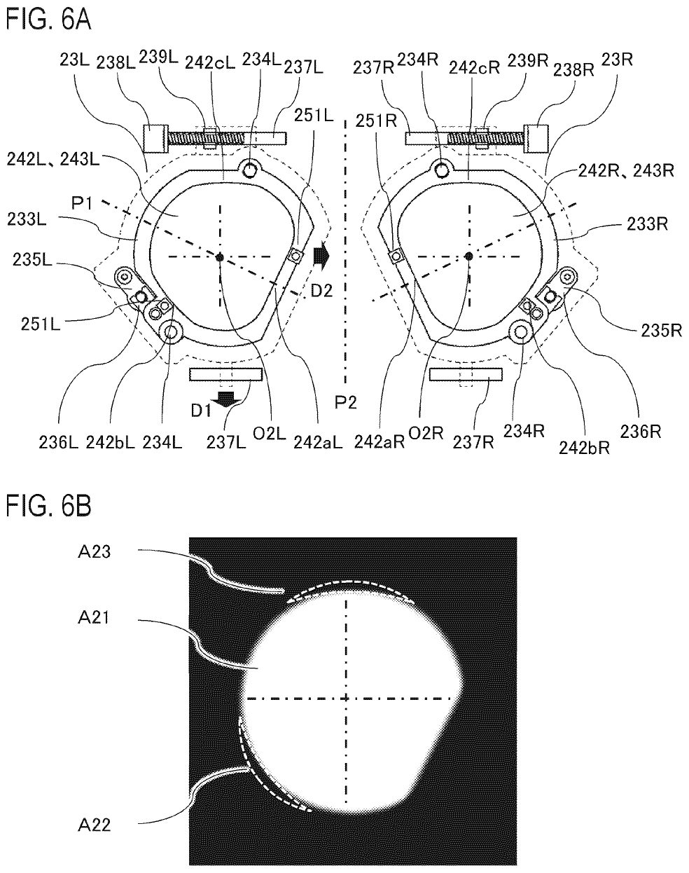

The HMD 2 has the following characteristics as will be described with reference to FIG. 6A. FIG. 6A shows the left and right display units 23L and 23R as viewed by the user in the directions of optical axes O2L and O2R. Since this is a description of internal structures, the outer contours of the display units 23L and 23R are shown with broken lines. The lenses 242L and 242R and cover glasses 243L and 243R have the same outer contours and are shown in register.

In the display unit 23 of the HMD 2 in this embodiment, the lens 242 and cover glass 243 that are optical elements include a first clearance portion 242a, a second clearance portion 242b, and a third clearance portion 242c in their outer contour. In this embodiment, the first clearance portion 242a, second clearance portion 242b, and third clearance portion 242c are portions of non-circular optical elements where the distance from the optical axis O2 is locally reduced.

More specifically, the first to the third clearance portions 242a, 242b, and 242c in this embodiment are formed as convex circular arc portions having a larger radius of curvature than the outermost edge of a circular arc substantially along an imaginary circle about the optical axis O2 in the outer shape of the lens 242 when viewed in the direction of the optical axis. The phrase “convex circular arc portions” is used here to describe the shape of each clearance portion merely because it refers to the (two-dimensional) shape when viewed in the direction of the optical axis. Obviously, each clearance portion has an arched (curved) surface when described in three dimensions because the lens 242 has a thickness in the direction of the optical axis.

The second clearance portion 242b and the third clearance portion 242c are substantially mirror symmetric about a plane P1 passing through the center of the first clearance portion 242a and the optical axis O2.

In this embodiment, of the clearance portion 242a, clearance portion 242b, and clearance portion 242c, the first clearance portion 242a is positioned on the lower side of the lens 242 and the cover glass 243 indicated by direction D1 and on the side closer to the other display unit (display unit 23R) indicated by direction D2. The second clearance portion 242b is adjacent some parts of the first driver (first motor 235, first guide bars 234, and first coupling member 236) and the eye camera 251. The third clearance portion 242c is adjacent some parts of the first driver (first guide bars 234) and of the second driver (second motor 238, second guide bars 237, and second coupling member 239).

In the two display units 23L and 23R, the lenses 242L and 242R and the cover glasses 243L and 243R with these clearance portions are positioned substantially in mirror symmetry about a plane P2 perpendicular to the left and right direction.

The advantageous effects of this embodiment will be described. Similarly to the HMD 1 of the first embodiment, the HMD 2 of this embodiment allows the first clearance portion 242a and the second clearance portion 242b to have different cutout shapes while enabling the left and right optical elements to have the same shape.

FIG. 6B is a diagram illustrating the viewing angle of images the user sees in the left eye display unit 23. A21 denotes the area of the viewing angle of the image visible to the user. A22 denotes the area of the viewing angle lost by providing the second clearance portion 242b. A23 denotes the area of the viewing angle lost by providing the third clearance portion 242c.

Let us now compare the viewing angle of the HMD 2 shown in FIG. 6B with the viewing angle of the HMD 9 shown in FIG. 7B. By forming the second clearance portion 242b, which is the driver clearance portion, as a minimum necessary cutout, the loss of viewing angle can be reduced from area A92 in FIG. 7B to area A22 in FIG. 6B. Area A23 in FIG. 6B is lost by providing the third clearance portion 242c. Even so, the lost area of the viewing angle, area A22 and area A23 combined, is reduced. Thus size and cost reductions are achieved while the unnecessary reduction of the viewing angle, which was an issue in HMDs, is prevented.

In the HMD 2, the second clearance portion 242b is adjacent one of the two eye cameras 251 (first camera). It is preferable to arrange the eye camera 251 as close to the optical axis O2 as possible to monitor the eye without the eyelid or eyelash obscuring the pupil. Providing the eye camera adjacent the second clearance portion 242b in the optical element allows it to be arranged close to the optical axis O2. Therefore, it is preferable to position one of the second clearance portion 242b and the third clearance portion 242c adjacent the eye camera.

In the HMD 2, the first clearance portion 242a is adjacent the other one of the two eye cameras 251 (second camera). This camera 251 is positioned at about the same height as the optical axis O2, i.e., by being adjacent the first clearance portion 242a, the camera can be positioned close to the optical axis O2.

In the HMD 2, the first driver drives the lens 242 that is an optical element included in the display unit 23 in directions substantially parallel to the optical axis O2. The second driver drives the lens 242 and the cover glass 243 that are optical elements included in the display unit 23 in the left and right direction indicated by D7. The clearance portions provided to the optical elements adjoin these driver. The first driver allows the focal length of images to be changed, while the second driver can help improve the image display performance. At least one of these drivers is preferably positioned adjacent a clearance portion in the optical element, so that the above-described vision adjustment effect can be achieved while allowing the HMD to be reduced in size.

In the HMD 2, the second clearance portion 242b is adjacent some parts of the first driver that drives the lens 242 that is an optical element in directions substantially parallel to the optical axis O2. The third clearance portion 242c is adjacent some parts of the second driver that drives the lens 242 and the cover glass 243 that are optical elements in the left and right direction. Positioning the first driver and second driver adjacent the same clearance portion would cause a local size increase in the display unit 23. Therefore, arranging at least some parts of separate drivers adjacent the second clearance portion 242bL or 242bR and the third clearance portion 242cL or 242cR enables the display unit to stay small with two or more drivers, which is preferable.

Other preferred arrangements to better achieve the effects of the present disclosure are the same as in the HMD 1.

Various configurations of the embodiments described above can be combined when feasible.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-038085, filed on Mar. 12, 2024, which is hereby incorporated by reference herein in its entirety.

What is claimed is:

1. A display apparatus comprising:
a pair of display units configured to present an image to left and right eyes, the pair of display units each including an optical element,
wherein the optical element includes
a first clearance portion, a second clearance portion, and a third clearance portion provided in different positions in an outer edge of the optical element when viewed in a direction of an optical axis, and has
a substantially mirror symmetric shape relative to an imaginary plane passing through a point on the first clearance portion and the optical axis.

2. The display apparatus according to claim 1, wherein the first clearance portion is provided in a position facing a nose.

3. The display apparatus according to claim 1, wherein the point on the first clearance portion is a contour center of the first clearance portion.

4. The display apparatus according to claim 1, wherein, when viewed in the direction of the optical axis,
a minimum distance from the first clearance portion to the optical axis is defined as a first distance, and
each of a minimum distance from the second clearance portion to the optical axis and a minimum distance from the third clearance portion to the optical axis is defined as a second distance, which is different from the first distance.

5. The display apparatus according to claim 4, wherein the first distance is shorter than the second distance.

6. The display apparatus according to claim 1, wherein the first clearance portion is provided on a lower side of the optical element and on a side where the pair of optical elements face each other.

7. The display apparatus according to claim 6, wherein the second clearance portion is provided on a lower side of the optical element and on a side opposite to the side where the pair of optical elements face each other.

8. The display apparatus according to claim 7, wherein the third clearance portion is provided on an upper side of the optical element.

9. The display apparatus according to claim 1,
wherein the display units each include a driver configured to displace the optical element in a predetermined direction, and
wherein the second clearance portion and the third clearance portion are each provided in a position facing at least a part of the driver.

10. The display apparatus according to claim 9,
wherein the driver includes:
an actuator configured to generate a driving force for displacing the optical element; and
a guide mechanism configured to guide the optical element so that the optical element is displaced in the predetermined direction,
wherein the second clearance portion is provided in a position facing at least the actuator,
wherein the third clearance portion is provided in a position facing at least the guide mechanism.

11. The display apparatus according to claim 9, wherein the predetermined direction is either a direction substantially parallel to the optical axis or a direction in which the pair of optical elements are aligned.

12. The display apparatus according to claim 9, further comprising a main body configured to hold the display units,
wherein the driver includes:
a first driver configured to displace the optical element in each of the display units; and
a second driver configured to displace the display units in the main body,
wherein the first driver displaces the optical element in a direction substantially parallel to the optical axis, and
wherein the second driver displaces the display units in a direction in which the pair of optical elements are aligned.

13. The display apparatus according to claim 1,
wherein the display units each include a camera for monitoring an eye, and
wherein one of the second clearance portion and the third clearance portion is provided in a position facing the camera.

14. The display apparatus according to claim 13,
wherein the camera includes a first camera and a second camera,
wherein one of the second clearance portion and the third clearance portion is provided in a position facing the first camera, and
wherein the first clearance portion is provided in a position facing the second camera.

15. The display apparatus according to claim 1, wherein the clearance portions are portions recessed toward the optical axis from an outermost portion of a circular arc substantially along an imaginary circle about the optical axis when viewed in the direction of the optical axis.

16. The display apparatus according to claim 15, wherein the clearance portions are linear portions in an outer edge shape of the optical element when viewed in the direction of the optical axis.

17. The display apparatus according to claim 15, wherein the clearance portions are convex circular arc portions in an outer edge shape of the optical element and having a larger radius of curvature than the outermost portion, when viewed in the direction of the optical axis.

18. The display apparatus according to claim 1,
wherein, with the optical elements being defined as a pair of first optical elements,
the pair of display units further include a pair of second optical elements, the second optical elements being aligned along the direction of the optical axis relative to the pair of first optical elements, and
wherein the second optical elements include a clearance portion in a position corresponding to at least one of the first clearance portion, the second clearance portion, and the third clearance portion.

19. An optical element provided in each of a pair of display units presenting images to left and right eyes in a display apparatus, the optical element comprising:
a first clearance portion, a second clearance portion, and a third clearance portion provided in different positions in an outer edge of the optical element when viewed in a direction of an optical axis,
the optical element having a substantially mirror symmetric shape relative to an imaginary plane passing through a center of the first clearance portion and the optical axis.
